(19) United States
(12) Patent Application Publication
(10) Pub. No.: US 2005/0199631 A1
(43) Pub. Date: Sep. 15, 2005

(54) Beverage tap spout plug

(76) Inventor: Raymond Alois, Baldwin, NY (US)

Correspondence Address: HOFFMANN & BARON, LLP, 6900 JERICHO TURNPIKE, SYOSSET, NY, 11791, US

(21) Appl. No.: 11/125,903

(22) Filed: May 10, 2005

Related U.S. Application Data
(63) Continuation-in-part of application No. 10/372,259, filed on Feb. 25, 2003, now abandoned.

(51) Int. Cl. B67D 5/56

(52) U.S. Cl. 220/375; 222/543; 222/563

(57) ABSTRACT

A combination of a beverage tap and a tap spout plug. The beverage tap includes a tap spout having an opening for dispensing a beverage and the tap spout plug includes an appendage and a handle attached to the appendage. The appendage is configured to frictionally fit in the tap spout opening to seal the beverage tap from contaminants and the handle is provided to facilitate insertion and removal of the tap spout plug with respect to the tap.

### CROSS-REFERENCE TO RELATED APPLICATIONS

This application is a continuation-in-part application of U.S. application Ser. No. 10/372,259, filed Feb. 5, 2003.

### FIELD OF THE INVENTION

The present invention relates to a cap for a liquid dispenser. More particularly, the present invention relates to a protective plug for a beverage tap spout.

### BACKGROUND OF THE INVENTION

Numerous innovations for soda and beer tap covers have been provided in the prior art that are described as follows. Even though these innovations may be suitable for the specific individual purposes to which they address, they differ from the present invention as hereinafter contrasted.

In U.S. Pat. No. 6,158,626 by inventor, Guerra, et al., titled Beverage Dispenser Stanchion cover, a cover for a beverage dispenser stanchion, such as a draft beer tower or the like, having a front containing a tap and a back substantially distal to the tap. The cover comprises a housing shaped to contain at least the stanchion back. The housing comprises a body having a top region, a bottom and a longitudinal opening extending substantially from the body top region to the body bottom, the opening for receiving the stanchion, and adapted to have at least the stanchion front extending outwardly therefrom, the opening further adapted to have the tap extending outwardly and operatively therefrom. A mechanism is provided for quickly and removably mounting the housing to the stanchion.

In U.S. Pat. No. 5,750,905, by inventor, Weimer, et al., titled, Beverage Dispenser Tap Cover With Position Sensing Switch, existing beverage dispensing taps may be retrofitted with a mechanism that provides an electrical signal which indicates when the tap is open. That mechanism includes a housing with an open bottom for placement over the tap with a lever of the tap projecting upward through an aperture in the housing. The housing is held in place over the tap by a compression bonnet that holds the operating lever on a conventional beverage tap. A switch assembly within the housing is engaged and operated by a component of the beverage tap to provide the electrical signal. The switch assembly has a unique double action actuator that tolerates different amounts of movement of the tap component. The actuator has a ring that is engaged by the tap component to operate the switch assembly and an annular flange secured to the housing. A first flexible web connects the ring to the annular flange and a button with a surface with a conductive surface is coupled to the ring by a second flexible web. When the switch is closed the conductive surface abuts a pair of contacts.

In U.S. Pat. No. 4,779750, by inventor, Armstrong, titled, Beer Keg Cap, a removable thermoplastic cap for a beer keg bushing comprising a flat disc with integral peripheral skirt which includes interned upwardly directed gripping lugs preventing removal of the cap when once fitted to a beer keg bushing, vertical slots spaced around the skirt and extending partway across the disc to provide venting for the interior of the bushing, and a pull tab provided on one side of the disc and connected by weakened lines to the opposite side thereof to facilitate peeling off of the cap by tearing apart the skirt.

Numerous innovations for soda and beer tap covers have been provided in the prior art that are adapted to be used. Even though these innovations may be suitable for the specific individual purposes to which they address, they would not be suitable for the purposes of the present invention as heretofore described. For example, the types of problems encountered in the prior art are that beer and wine dispensers, called “towers” or “taps” allow bacteria and other microorganisms to enter therein through the opening in their spout.

In the prior art, unsuccessful attempts to solve this problem were attempted namely: non-replaceable dispenser covers. Other innovations within the prior art are rapidly being exploited in the fields of sanitary products.

### SUMMARY OF THE INVENTION

The present invention is a combination of a beverage tap and a tap spout plug. The beverage tap includes a tap spout having an opening for dispensing a beverage and the tap spout plug includes an appendage and a handle attached to the appendage. The appendage is configured to frictionally fit in the tap spout opening to seal the beverage tap from contaminants and the handle is provided to facilitate insertion of the tap spout plug into the spout and the removal of the tap spout plug from the spout.

In a preferred embodiment, the tap spout plug further includes a strap attached at a first end to one of the appendage and the handle. The strap has an opposite second end adapted for attachment to the beverage tap. The strap may be integrally formed with one of the appendage and the handle and may also be formed with an opening at its second end for inserting the strap first end therethrough to form a loop for attachment to the beverage tap. Also, the strap may further include a plurality of teeth formed thereon that are engageable with the strap opening.

The plug appendage preferably includes a first portion extending from the handle and a second portion extending from and axially aligned with the first portion. The first portion has a maximum width greater than a maximum width of the second portion, wherein the plug appendage is adapted to be removably insertable into at least two differently sized tap spout openings. Additionally, the first and second portions are preferably conical in shape, wherein the maximum width of the first portion is disposed adjacent the handle and the maximum width of the second portion is disposed adjacent the first portion.

The present invention further involves a method for sealing a beverage tap spout from contaminants. The method generally includes the steps of providing a tap spout plug including an appendage and a handle, wherein the appendage is configured to frictionally fit in a tap spout opening of the beverage tap, grasping the tap spout plug by the handle and inserting the plug appendage into the tap spout opening thereby sealing the beverage tap from contaminants. The tap spout is opened by grasping the tap spout plug by the handle, twisting and/or pulling the handle and removing the tap spout plug from the tap spout opening, thereby permitting dispensing of the beverage.

The aforementioned patents significantly differ from the present invention because the patented inventions fail to describe and/or claim one or more of the following: disposable or dish washable cap which is capable of snapping on or easily fastenable and conforms to any angle and of spout.

The present invention went contrary to the teaching of the art which describes and claims covers for beer and soda spouts.

The present invention solved a long felt need to a disposable sanitary insert.

Accordingly, it is an object of the present invention to provide a tap cap having a plug, cap, and strap.

More particularly, it is an object of the present invention to provide a plug having a plug handle, plug handle indicia, plug appendage, and plug appendage tread.

In keeping with these objects, and with others which will become apparent hereinafter, one feature of the present invention resides, briefly stated, in the cap having a cap thread.

When the strap is designed in accordance with the present invention, it has a strap first end with a strap first end opening and strap first end teeth.

In accordance with another feature of the present invention, the strap also has a strap second end with a strap second end opening.

The novel features which are considered characteristic for the invention are set forth in the appended claims. The invention itself, however, both as to its construction and its method of operation, together with additional objects and advantages thereof, will be best understood from the following description of the specific embodiments when read and understood in connection with the accompanying drawings.

### BRIEF DESCRIPTION OF THE DRAWINGS

FIG. 1 is a front perspective view of a tap cap (10).

FIG. 2 is an upper left perspective view of a tap cap (10) inserted into a tap spout opening (18AA) of a tap spout (18).

FIG. 3 is a front view of a cap (14) being inserted onto a plug appendage (12B).

FIG. 4 is a front perspective view an alternative embodiment of the present invention.

FIG. 5 is a front perspective view of another alternative embodiment.

### DETAILED DESCRIPTION OF THE PREFERRED EMBODIMENT

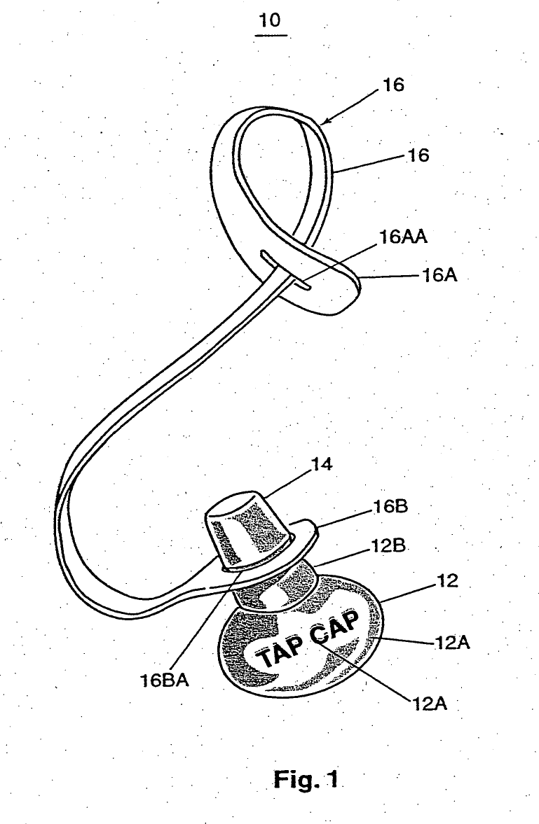

Referring to FIG. 1 which is a front perspective view of a tap cap 10 removably insertable into a tap spout opening 18AA of a tap spout 18A. The tap cap 10 comprises a plug 12 having a plug handle 12A positioned at one end securely connected to a plug appendage 12B positioned and extending outwardly from the opposite side.

The tap cap 10 further comprises a cap 14 having a complimentary configuration to the plug appendage 12B. The cap 14 is removably positioned over the plug appendage 12B.

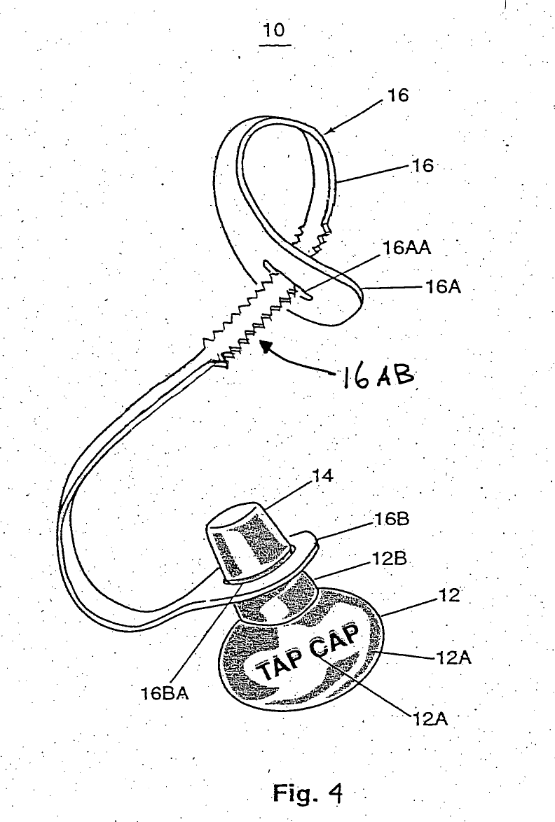

The tap cap 10 further comprises a strap 16 having a strap first end 16A and a strap second end 16B. The strap first end 16A having a strap first end opening 16AA through which the strap second end 16B is inserted therethrough forming a loop. The strap second end 16B is attachable to the plug 12. In an alternative embodiment as shown in FIG. 4, the strap first end 16A preferably further comprises a plurality of strap first end teeth 16AB functioning to engage an outer periphery of the strap first end opening 16AA. The plug handle 12A may optionally comprise plug handle indicia 12AA thereon. The plug handle indicia 12AA is preferably embossed or raised.

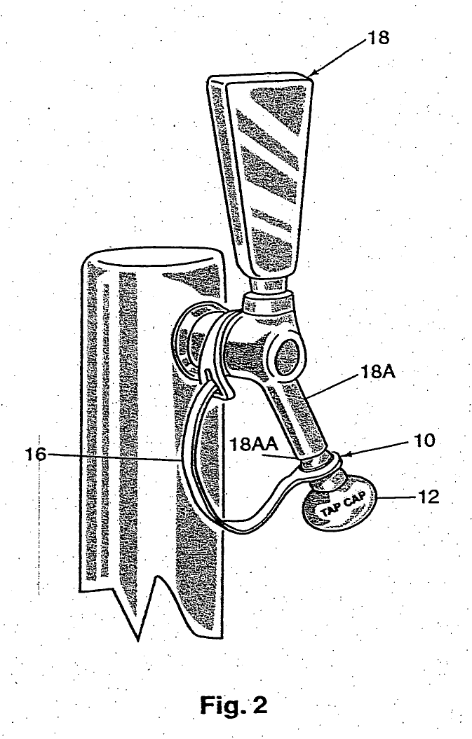

Referring to FIG. 2 which is an upper left perspective view of a tap cap 10 inserted into a tap spout opening 18AA or a tap spout 18A.

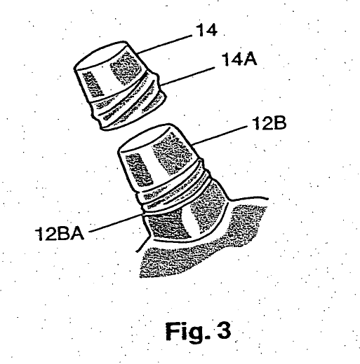

Lastly, referring to FIG. 3 which is a front view of a cap 14 being inserted onto a plug appendage 12B. The plug appendage 12B further comprises plug appendage thread 12BA having a complimentary configuration to a cap thread 14A positioned on the cap 14. The plug appendage thread 12BA and cap thread 14A function to securely hold the cap 14 onto the plug appendage 12B during insertion and removal into and from the tap spout opening 18AA. The strap second end 16B further comprises a strap second end opening 16BA through which the plug appendage 12B is securely positioned. The cap 14 screws onto the plug appendage 12B and remains securely attached thereto. The cap 14 is preferably disposable.

The tap spout plug assembly 10 as shown in FIG. 2 can be first attached to the tap spout 18 by removably attaching the strap 16 to the tap spout 18. The strap first end 16B is inserted through strap first end opening 16AA to form a loop that allows the tap spout plug assembly 10 to be held in close proximity to the spout. The user then can grasp the tap spout plug assembly 10 by the plug handle 12A. The user then inserts the plug appendage 12B into the tap spout opening 18AA to form a friction fit between the plug appendage 12B and the tap spout opening 18AA. The user can simultaneously push and twist the tap spout plug assembly 10 into the tap spout 18A to create a fluid tight seal. An advantage of using the tap spout plug assembly 10 is that the plug handle 12A allows the user to have adequate leverage to insert the plug appendage 12B into the tap spout opening 18AA. In order to remove the tap spout plug assembly 10 the user only has to grasp the plug handle 12 and pull the plug appendage 12B out of the tap spout opening 18AA. The user can easily use the plug handle 12A to slightly twist the entire tap spout plug assembly 10 in those instances that the plug appendage 12B is tightly wedged in the tap spout opening 18AA.

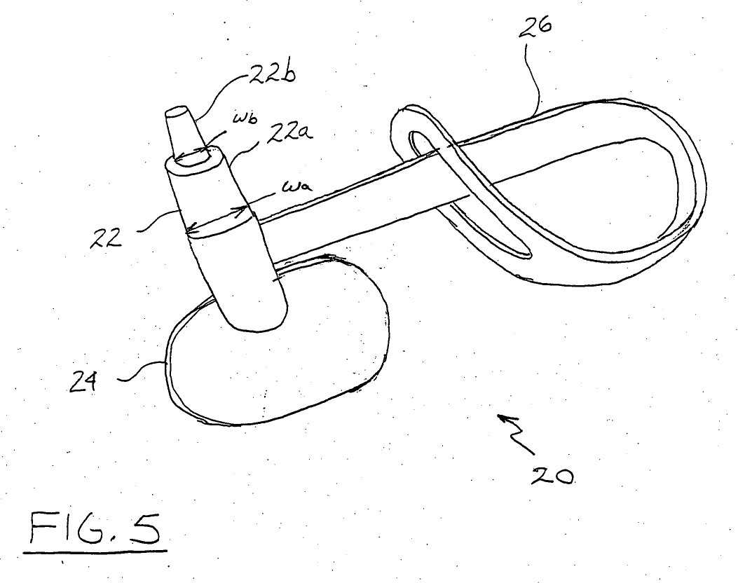

In an alternative embodiment, as shown in FIG. 5, a tap spout plug 20 again generally includes a plug appendage 22, a handle 24 attached to the appendage and a strap 26 for attaching the plug to a beverage tap as described above. Again, the strap 26 can be made removable from the plug 20 or it can be made integral with either the appendage 22 or the handle 24.

In this embodiment, however, the plug appendage 22 includes a first portion 22a extending from the handle 24 and a second portion 22b extending from the first portion. The first and second portions 22a and 22b are axially aligned and the first portion 22a has a maximum width wₐ which is greater than the maximum width w_{b} of the second portion 22b. Preferably, the first and second portions are conical in shape wherein the maximum width wₐ of the first portion 22a is disposed adjacent the handle 24 and the maximum width w_{b} of the second portion 22b is disposed adjacent the first portion. Each portion 22a and 22b preferably tapers at about a 2 degree angle from its maximum width to its minimum width.

With this design, the tap spout plug 20 is adapted to fit in differently sized tap spout openings and the tapering conical shape accounts for any variances in the size of the openings due to manufacturing tolerances. For example, while most beer tap spout opening are of a standard size, tap spouts for wine taps have a different sized opening which the tap spout plug of the present invention can accommodate.

It will be understood that each of the elements described above, or two or more together, any also find a useful application in other types of constructions differing from the type described above.

While the invention has been illustrated and described as embodied in a soda and beer tap covers, it is not intended to be limited to the details shown, since it will be understood that various omissions, modifications, substitutions and changes in the forms and details of the device illustrated and in its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

1. In combination:
a beverage tap including a tap spout having an opening for dispensing a beverage; and
a tap spout plug including an appendage configured to frictionally fit in said tap spout opening to seal said beverage tap from contaminants and a handle attached to said appendage to facilitate insertion and removal of said tap spout plug with respect to said tap.

2. A combination as defined in claim 1, wherein said tap spout plug further comprises a strap attached at a first end to one of said appendage and said handle, said strap having an opposite second end adapted for attachment to said beverage tap.

3. A combination as defined in claim 2, wherein said strap is integrally formed with one of said appendage and said handle.

4. A combination as defined in claim 2, wherein said strap second end includes an opening for inserting said strap first end therethrough to form a loop for attachment to said beverage tap.

5. A combination as defined in claim 4, wherein said strap further comprises a plurality of teeth formed thereon, said teeth being engageable with said strap opening.

6. A combination as defined in claim 1, wherein said plug appendage comprises a first portion extending from said handle and a second portion extending from and axially allowed with said first portion, said first portion having a maximum width greater than a maximum width of said second portion, wherein said plug appendage is adapted to be removably insertable into at least two differently sized tap spout openings.

7. A combination as defined in claim 6, wherein said first and second portions are conical in shape, wherein said maximum width of said first portion is disposed adjacent said handle and said maximum width of said second portion is disposed adjacent said first portion.

8. A combination as defined in claim 1, further comprising a plug cap removably attachable to said plug appendage when said appendage is removed from said tap spout opening.

9. A method for sealing a beverage tap from contaminants comprising the steps of:
providing a tap spout plug including an appendage and a handle, said appendage configured to frictionally fit in a tap spout opening of said beverage tap;
grasping said tap spout plug by said handle; and
inserting said plug appendage into said tap spout opening thereby sealing said beverage tap from contaminants

10. A method as defined in claim 9, further comprising the steps of:
twisting and/or pulling the handle; and
removing the tap spout plug from the tap spout opening, thereby permitting dispensing of the beverage.

11. A method as defined in claim 9, further comprising the step of attaching a strap of said tap spout plug to said beverage tap.
